(19) United States
(12) Patent Application Publication
(10) Pub. No.: US 2016/0358766 A1
(43) Pub. Date: Dec. 8, 2016

(54) REDUCING OVERFRAGMENTATION IN ULTRAVIOLET PHOTODISSOCIATION

(71) Applicant: Thermo Finnigan LLC, San Jose, CA (US)

(72) Inventors: Chad R. WEISBROD, San Jose, CA (US); Jae C. SCHWARTZ, Gilroy, CA (US); John E. P. SYKA, Charlottesville, VA (US)

(21) Appl. No.: 15/171,731

(22) Filed: Jun. 2, 2016

Related U.S. Application Data
(60) Provisional application No. 62/170,636, filed on Jun. 3, 2015.

(51) Int. Cl. H01J 49/42

(52) U.S. Cl. CPC H01J 49/4225

(57) ABSTRACT

A method and apparatus are disclosed for dissociation of precursor ions, such as polypeptides, by ultraviolet photodissociation (UVPD) for mass spectrometry analysis. Precursor ions are confined within an ion trap and irradiated with ultraviolet (UV) light, which may take the form of pulses emitted by a laser. The precursor ions absorb the UV light and dissociate into product ions. To avoid the condition of overfragmentation arising from further dissociation of the product ions, an excitation field is established within the ion trap such that the product ions, but not the precursor ions, are kinetically excited to trajectories that extend outside of the irradiated region.

### CROSS-REFERENCE TO RELATED APPLICATIONS

This application claims the priority benefit of U.S. provisional patent application Ser. No. 62/170,636 for “Methods for Performing Ultraviolet Photodissociation for Mass Spectrometry” by Chad R. Weisbrod, et al., filed Jun. 3, 2015, the entire disclosure of which is incorporated herein by reference.

### TECHNICAL FIELD

The invention relates generally to methods for dissociating ions for analysis by mass spectrometry, and more specifically to a method of ultraviolet photodissociation (UVPD).

### BACKGROUND

Analysis of samples by mass spectrometry may involve the use of one or more stages of ion dissociation, referred to as MS/MS or MSn analysis. The dissociation of ions generated from a sample yields characteristic product ions, and the measured intensities and mass-to-charge ratios (m/z's) of these product ions may be useful for structural elucidation, as well as for detecting and/or quantifying targeted analytes with high specificity. Historically, dissociation has been most commonly performed in mass spectrometers by collisionally activated dissociation (CAD) techniques, which utilize relatively high-energy collisions between precursor analyte ions and a neutral gas such as helium, nitrogen or argon (commonly referred to as collision gas) to generate product ions consisting primarily of the thermodynamically favored fragments or b- and y-type ions.

While CAD has been successfully employed for analysis of a wide variety of molecules, including biomolecules such as peptides, certain more recently developed dissociation techniques have been found to be particularly useful for analysis of intact proteins and post-translationally modified peptides, among other molecules. One such technique is ultraviolet photodissociation (UVPD), in which analyte precursor ions are irradiated with ultraviolet (UV) radiation produced by a UV source, typically a laser. For polypeptide analytes, absorption of UV radiation causes fragmentation to proceed through all known peptide backbone fragmentation pathways, producing primarily a- and x-type fragment ions, but also b-, c-, y-, and z-type fragment ions as well as side-chain fragment ions. The principles and usage of UVPD are described by Brodbelt (Journal of the American Chemical Society, (2013), 134(34), pp. 12646-12651) and by Reilly et al. (U.S. Pat. No. 7,618,806B2), the disclosures of which are incorporated herein by reference.

In UVPD, fragmentation efficiency (measured either in terms of the depletion of precursor ions or the production of fragment ions) increases with the duration of exposure of the precursor ions to the UV radiation. However, UV irradiation over a prolonged period can promote production of higher order reaction products (secondary, tertiary, etc.). The generation of higher-order products ions is accompanied by the production of internal sequence fragment ions, which are generally not useful for derivation of sequence information and serve to complicate spectral interpretation and reduce the achievable signal-to-noise ratio (SNR) of desired product ions. Minimization of these internal fragments and other chemical noise sources generated as a byproduct of UVPD is central to improvement in product ion spectral SNR and overall sequence coverage.

### SUMMARY OF THE INVENTION

Generally described, embodiments of the present invention include a method for dissociating ions by UVPD in which ion species other than the precursor ion are kinetically excited to trajectories that reduce exposure to the UV radiation. More specifically, the method includes establishing a confinement field in an ion trap to substantially confine the precursor ions within an ion cloud. A region of the ion trap, overlapping with the ion cloud, is irradiated with UV radiation such that some of the precursor ions absorb the UV radiation and undergo fragmentation into product ions. During at least part of the time while the precursor ions are irradiated (the irradiation period), an excitation field is generated within the ion trap that kinetically excites the product ions into trajectories that extend outside of the irradiation region. In this manner, the remaining precursor ions may continue to be exposed to the UV radiation, while avoiding or reducing the production of internal fragment ions associated with the generation of higher-order reaction products.

In more particular embodiments, the ion trap may be a two-dimensional quadrupole ion trap, and the excitation field may be a substantially dipolar field or a quadrature excitation field. The precursor ions may be irradiated with a continuous beam of UV radiation, or may alternatively be irradiated with a plurality of UV radiation pulses. In the case of pulsed radiation, each of the pulses may have an energy of between 0.1 μJ and 8 mJ. The precursor ions may be polypeptide ions, such as intact protein ions. Excitation of the product ions may be achieved by applying a notched multifrequency waveform to at least one ion trap electrode, with the frequency notch corresponding to the secular frequency of the precursor ions. The excitation field may be controlled to avoid loss of product ions by ejection/collision with ion trap electrodes, and/or further fragmentation of the product ions via collisionally activated dissociation.

### BRIEF DESCRIPTIONS OF THE DRAWINGS

In the accompanying drawings:

FIG. 1 is a symbolic diagram of an ion trap and UV radiation source that may be utilized to practice embodiments of the present invention;

FIG. 2 is a lateral cross-sectional view of the ion trap and ions confined therein, showing the excursion of product ions outside of the irradiated region when a dipolar excitation field is applied;

FIG. 3 is a lateral cross-sectional view of the ion trap and ions confined therein, showing the excursion of product ions outside of the irradiated region when a quadrupolar excitation field is applied; and

FIG. 4 depicts spectra acquired after UVPD irradiation with and without product ion excitation.

### DETAILED DESCRIPTION

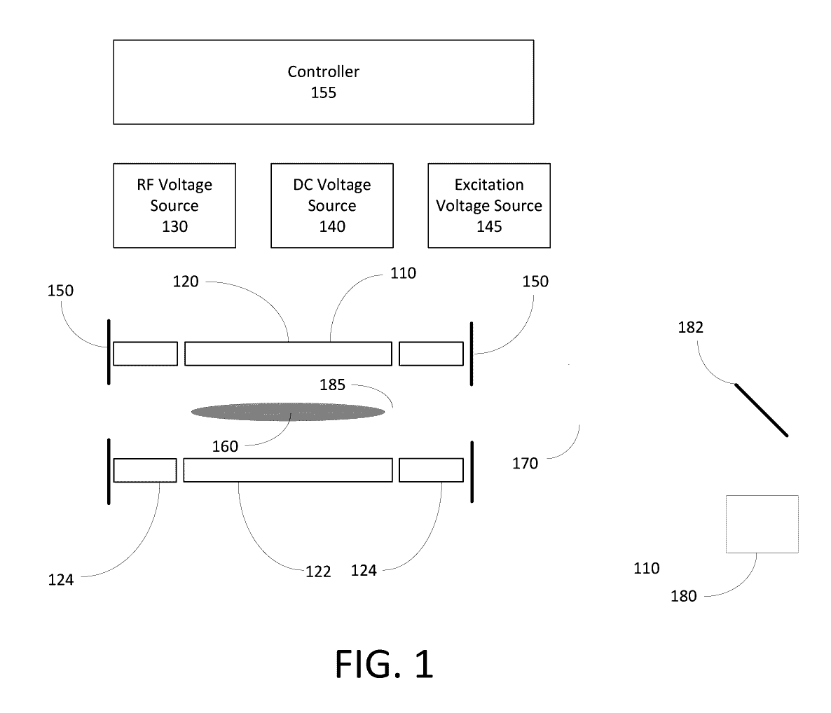

FIG. 1 symbolically depicts an ion trap 110 and UV source 120 that may be utilized to implement the dissociation method described herein. The principles and operation of ion traps are well-known in the art and need not be described in detail herein. In general, an ion trap is constructed from a number of electrodes to which oscillatory (and optionally direct current (DC)) voltages are applied to generate a confinement field that acts to confine ions to an interior volume. For certain types of ion traps, such as ion cyclotron resonance (ICR) traps, the trapping field may arise from a combination of applied electrical voltages and the presence of one or more magnets. In the illustrative example depicted in FIG. 1, ion trap 110 takes the form of a segmented linear (alternately referred to as two-dimensional) quadrupole ion trap consisting of four elongated electrodes 120 (only two of which are depicted in the drawing) arranged into pairs, each pair being opposed across the ion trap central axis. Each electrode is divided into three segments, consisting of a central segment 122 interposed between end segments 124. The electrode segments may be electrically isolated from each other to allow different DC voltages to be applied to generate a potential well, as described below.

In ion trap 110, radial confinement of ions is achieved by the application of a radio-frequency (RF) voltage to electrodes 120 by RF voltage source 130. In a typical mode of operation, the two electrode pairs receive an RF voltage of substantially equal amplitude in an opposite phase relationship. Confinement of ions in the longitudinal dimension (i.e., along the ion trap's central axis) may be effected by applying different DC voltages from DC voltage source 140 to the end 124 and central 122 segments of the electrodes to define a potential well that is roughly co-extensive with the length of the central segment. For example, if the confined ions are cations, the potential well may be established by applying DC voltages to the end segments that are higher relative to the DC voltage applied to the central segments. In other implementations, the DC potential well may be established by applying suitable DC voltages to end lenses 150 positioned axially outwardly of electrodes 120. The operation of RF voltage source 130 and DC voltage source 140, as well as excitation voltage source 145 and UV source 185 and other components of the associated mass spectrometer, is directed by controller 155, the function of which may be distributed across several discrete components, such as general-purpose and specialized processors, application-specific circuitry, memory and storage, and which may be configured to execute software code to implement one or more of the steps described below.

The combination of RF and DC fields described above confines unexcited ions to a thin, generally cylindrical volume located near the ion trap central axis and extending along the DC potential well (e.g., substantially coextensively with the central segments), referred to herein as ion cloud 160. As is known in the art, the dimensions of ion cloud 160, and specifically its radius, will vary according to the amplitude and frequency of the applied RF voltage, the m/z's and masses of the trapped ions, as well as the pressure of background gas within ion trap 110.

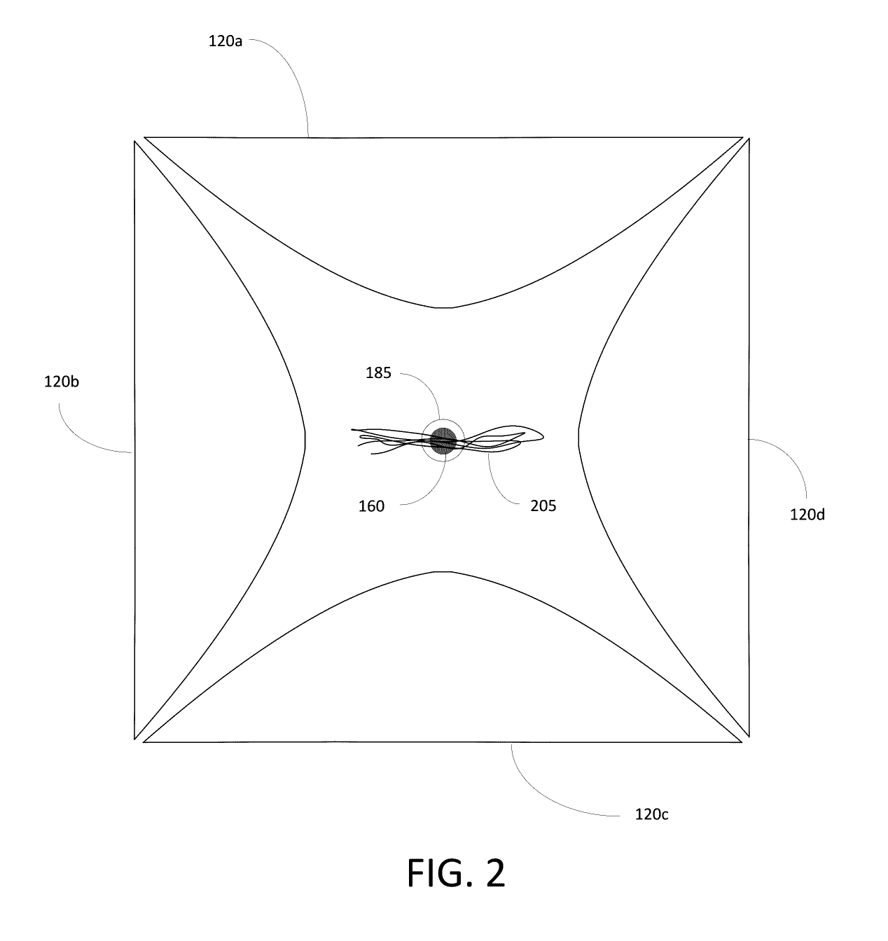

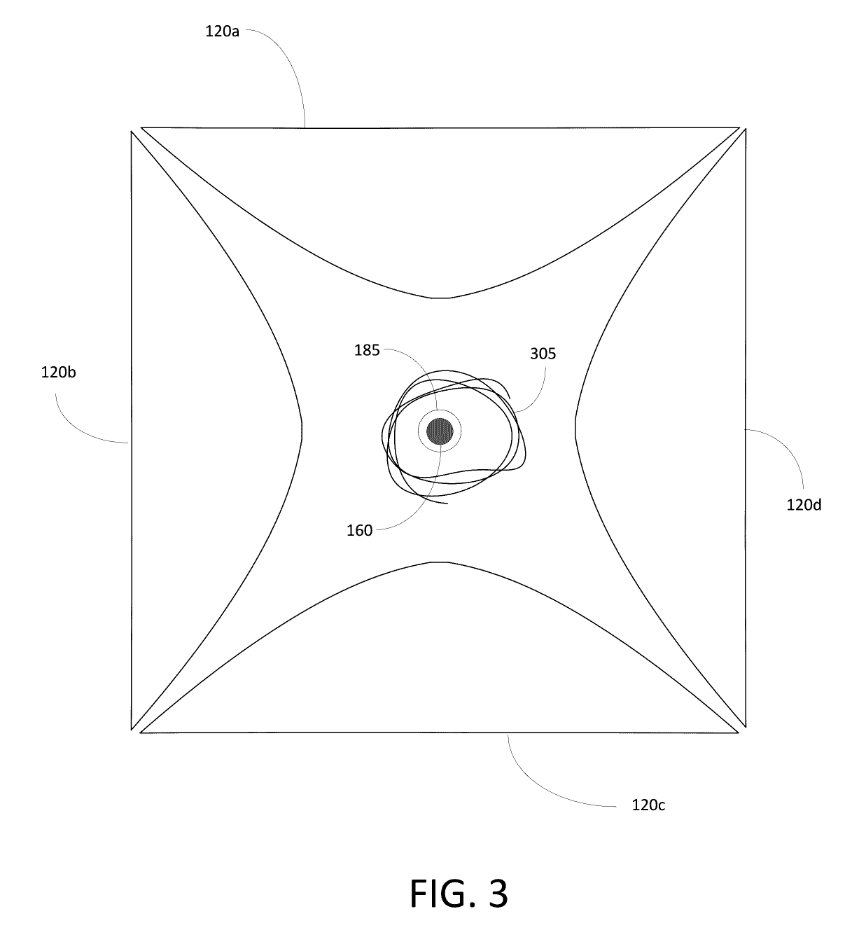

To dissociate ions in ion trap 110 by UVPD, a beam 170 of UV radiation of suitable properties is passed into ion trap 110, preferably along a path that is coaxial to or parallel to the ion trap central axis. UV beam 170 is emitted by a source 180 and the beam path may be directed along the ion trap by one or more reflectors or other ion optics, such as mirror 182. Source 180 may take the form of a laser or other device capable of emitting a UV radiation beam having properties (e.g., wavelength, power, pulse duration, repetition rate) suitable for causing absorption and consequent fragmentation by the analyte ions of interest. The region 185 of the ion trap 110 that is irradiated by UV beam 170 will be referred to herein as the “irradiated region”. The diameter and positioning of UV beam 170 are set or adjusted to give good overlap between ion cloud 160 and irradiated region 185, such that most or all of the unexcited ions within ion trap 110 (the deliberate excitation of ions will be discussed below in connection with FIGS. 2 and 3) are exposed to the UV radiation for consequent absorption and fragmentation. In the example depicted in FIGS. 1-3, ion cloud 160 is entirely enveloped by irradiated region 185, although this is not necessary to the practice of the invention, and in certain implementations a portion of the ion cloud may extend outside of the irradiation region.

In operation, a group of ions to be dissociated are introduced into the interior volume of ion trap 110. In a typical experiment, these ions are formed by ionization (e.g., in an electrospray ionization source) of proteins or peptides in a sample, although the invention should not be construed as being limited to use with any particular type of analyte compounds or ionization methods. A mass selection device, such as a quadrupole mass filter, may be operated upstream of ion trap 110 to select a particular precursor ion species of interest (e.g., a pseudo-molecular ion of a polypeptide) for dissociation in the ion trap. Introduction of ions may be done in a controlled manner by allowing ions (e.g., the ions selectively transmitted by the upstream quadrupole mass filter) to enter the ion trap for a predetermined period (referred to as the injection time, or IT), and accumulating the entering ions within the ion trap interior volume. The injection time may be calculated to fill ion trap 110 to a target number of ions based on the known or estimated ion flux. At the end of the injection time, additional ions may be prevented from entering ion trap 110 by applying appropriate DC offsets to lens 150 positioned at the ion trap entrance, or to other ion optical components positioned upstream in the ion path.

In certain implementations of the invention, a “multi-fill” approach may be adopted, whereby a first group of analyte ions are accumulated and confined within the ion trap and subsequently irradiated with UV to yield product ions, which are retained in the ion trap while second and successive groups of analyte ions are accumulated within the ion trap and irradiated.

After the ions are accumulated within ion trap 110, and optionally cooled to remove excess kinetic energy, UV source 180 is operated to direct a UV radiation beam into the ion trap interior, as discussed above. In one implementation, UV source 180 is a excimer laser (of the type sold by Coherent under the trademark ExciStar XS) which emits pulsed UV radiation at 193 nm with a pulse duration of 5 nanoseconds (ns), a repetition rate of 200 Hz, and a maximum pulse energy of 8 mJ. Other implementations may employ a solid-state laser, which may emit pulsed UV radiation at a wavelength of 213 nm as UV source 180. In order to achieve efficient fragmentation of the analyte ion species of interest and thereby provide information useful for sequencing, the confined ions may be irradiated with a series of multiple pulses of UV radiation (typically between 2 and 1000, and more typically between 2 and 20, with typical energy/pulse ranging between 0.1 μJ and 8 mJ), or, in the case where a continuous UV radiation source is employed, may be exposed to the continuous UV beam over a relatively prolonged period. As discussed above, this approach results in good fragmentation yields (as measured by the depletion of the precursor (analyte) ion and/or by the production of product ions), but may tend to cause production of higher order reaction products (secondary, tertiary, etc.) and the consequent generation of internal sequence fragment ions, which are generally not useful for derivation of sequence information and serve to complicate spectral interpretation and reduce the achievable signal-to-noise ratio (SNR) of desired product ions. This undesirable result, referred to as “overfragmentation” may be avoided or reduced in effect by the selective excitation technique described in the following sections.

FIG. 2 is a symbolic diagram depicts a lateral cross-section taken through central electrode segments 122 of ion trap 110. As discussed above, ion trap 110 may take the form of a two-dimensional quadrupole ion trap, having four elongated electrodes (here labeled 120a-d) arranged around the central axis. Electrodes 120a-d are depicted as having hyperbolic surfaces facing the central axis, although electrodes having other shapes (e.g., round or rectangular) may be substituted. The application of RF and DC voltages to electrodes 120a-d (or to other parts of ion trap 110) establish a confinement field that causes the analyte ions (e.g., the peptide or protein ion species selected by the upstream quadrupole mass filter) to occupy a narrow, generally cylindrical ion cloud 160 located near the central axis. Ion cloud 160 is shown to be enveloped by irradiated region 185. In the absence of the excitation technique implemented as described below, product ions that are formed by absorption of UV radiation and consequent fragmentation of the analyte ions would generally continue to be located within or proximate to ion cloud 160 and would thereby be exposed to the UV radiation, causing the—production of higher-generation fragment ions and the aforementioned overfragmentation problem.

To prevent or reduce over-fragmentation, product ions are selectively excited by an excitation field such that their trajectories extend outside of irradiated region 185. In the FIG. 2 example, this is accomplished by the establishment of a dipolar excitation field that causes the product ions to become kinetically excited in the dimension defined by electrodes 120b and 120d. A representative trajectory of an excited product ion is shown as 210. The dipolar excitation field may be generated by the application (by excitation voltage source 145) of a notched multifrequency waveform across electrodes 120b and 120d. The use of notched multifrequency waveforms for mass-selective excitation (or ejection) of ions within an ion trap is well-known in the mass spectrometry art and need not be discussed in detail herein. Generally described, such notched multifrequency waveforms are composed of a large number of regularly-spaced frequency components with a “notch” (omitted frequency component(s)) centered around a secular frequency of the ion species for which excitation (or ejection) is not desired (noting that secular frequency, which is the frequency of oscillatory movement in a trapping field, is a function of an ion's mass-to-charge ratio (m/z)). In the present case, the notch in the waveform is centered around the secular frequency of the analyte ion species, for example the peptide or protein ion selectively transmitted to ion trap 110 via the upstream quadrupole mass filter. In this manner, the analyte ions (which may also be referred to as the precursor ions) are not kinetically excited by the establishment of the excitation field, and therefore remain within irradiated region 185, such that these ions are exposed to the UV radiation. In contrast, the product ions formed by fragmentation of the analyte ions have secular frequencies that match or are close to component frequencies of the excitation waveform, causing them to pick up energy from the excitation field and become kinetically excited.

When a dipolar excitation approach is employed, as depicted in FIG. 2, the excited product ions pass periodically through irradiated region 185 and thus may be exposed to UV radiation during a part of their trajectories. However, because the excited ions are located outside irradiated region 185 for a substantial portion of the irradiation period, the likelihood that they will absorb UV radiation and undergo further fragmentation is substantially reduced. In preferred embodiments, the product ions are excited to trajectories which bring them outside of irradiated region for at least 90% of the irradiation period, or at least 99% of the irradiation period.

According to a variant of the foregoing excitation technique, two dipolar excitation waveforms, each consisting of a multifrequency waveform with a notch located at the secular frequency of the analyte (precursor ions) may be applied to the electrodes of ion trap 110, with one of the electrode pairs (e.g., electrodes 120b,d) receiving the first dipolar excitation waveform, and the other pair (e.g., electrodes 120a,c) receiving the second dipolar excitation waveform. This alternative technique is depicted in FIG. 3. The dipolar excitation fields may have frequency composition such that the same component frequencies in each waveform are in quadrature (out of phase by 90 degrees), such that the excited ions are driven in spiral-like trajectories (represented by trajectory 305), all or a substantial portion of which extend outside of irradiation zone 185. The resultant composite excitation field is referred to herein as a quadrature excitation field. Even if the ion frequencies are not the same in each radial dimension (i.e., the dimensions defined across each electrode pair) or because of differential frequency shifts (for example, different directions of oscillation amplitude depended frequency shift in each excitation dements) due to field imperfections, excitation of the product ions in both dimensions may reduce the fraction of time ions spend within the irradiation zone, and therefore potentially increase the effect of product ion excitation on overfragmentation reduction.

Irrespective of which excitation scheme is employed, the excitation field is established within ion trap 110 during all or part of the irradiation period. As used herein, the term “irradiation period” is defined as the time between the initiation of UV radiation and its final termination, and should be understood to include the time between pulses of radiation if a pulsed UV source is utilized. In certain implementations, establishment of the excitation field may be delayed until a prescribed time after the initiation of UV radiation. In other implementations, the excitation field is only established between pulses of UV radiation.

It is noted that the degree of excitation experienced by the product ions should be controlled to avoid excessive excitation leading to losses of product ions via ejection, collision with ion trap surfaces and/or further fragmentation caused by energetic collisions with background gas (i.e., CAD-type fragmentation). This objective may be met by adjustment of the excitation voltage waveform, and more particularly by appropriately setting the amplitudes of the frequency components.

Following termination of the irradiation period, the product ions may be mass analyzed to acquire a product ion spectrum, either in ion trap 110 or in another mass analyzer. In other implementations, the product ions, or a subset thereof, may be further processed (e.g., subjected to another stage of mass selection and fragmentation) prior to acquisition of a mass spectrum.

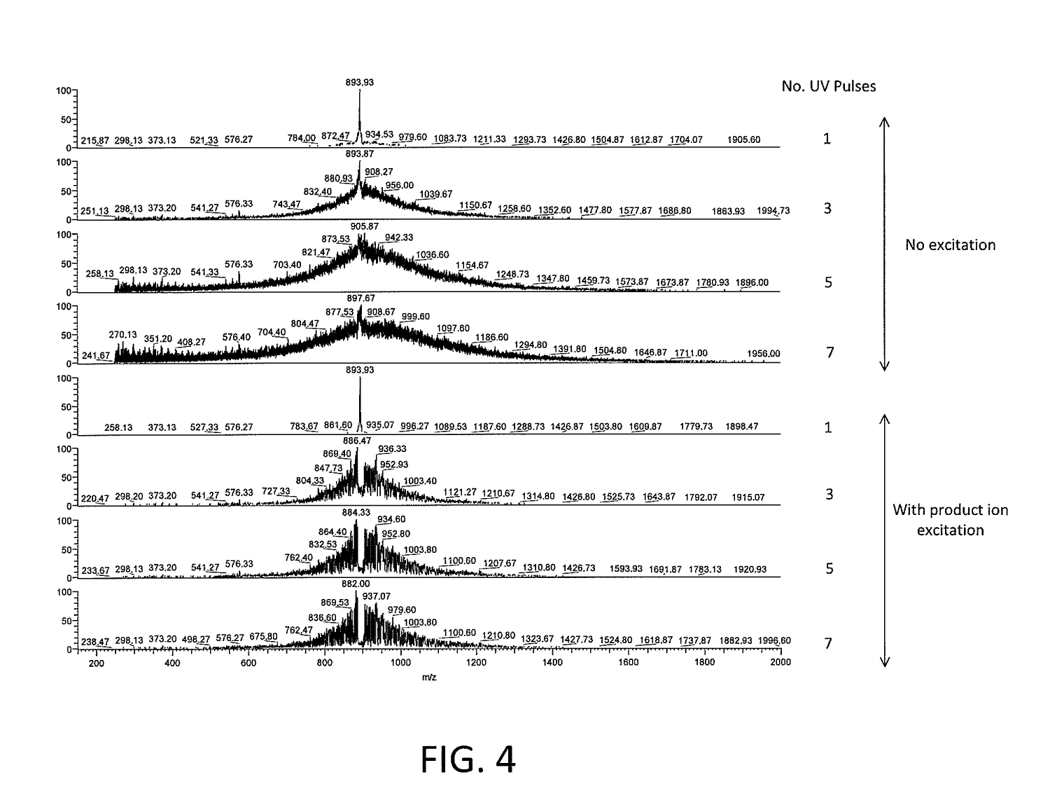

FIG. 4 depicts the effects of product ion excitation on the spectra acquired after irradiation of a group of apomyoglobin precursor ions with a specified number (1, 3, 5 and 7) of UV pulses. The top four spectra were obtained without use of product ion excitation. It may be discerned that as the number of UV pulses is increased, the product ion peaks are spread out around the entire range of m/z values in the spectrum, indicative of the further dissociation of product ions into higher-order reaction products. The bottom four spectra were obtained with product ion excitation, and show the product ion peaks as occupying a narrower range of m/z values (representative of decreased higher-order reaction product generation), while at the same time demonstrating the efficient conversion of the precursor ion into product ions.

It has been observed that, even absent use of the product ion excitation technique described above, that improved performance relative to conventional UVPD techniques are achieved through the use of multiple radiation pulses of relatively low energy/pulse rather than (as is conventionally employed) a single, relatively high energy pulse. For example, irradiating a protein ion analyte with multiple pulses (e.g., between 5 and 15) of UV radiation with pulse energy equal to or less than 0.1 mJ/pulse has been seen to provide improved sequence coverage relative to irradiation with a single pulse having an energy equal to the aggregate sum of the energies of multiple pulses.

Although embodiments of the instant invention described herein focus on to-down proteomic applications, it is envisaged that the methods described above may be applicable to many other areas of mass spectrometry including but not limited to lipidomics, genomics (nucleic acid sequences) and glycomics (carbohydrates).

It is further noted that the method and apparatus described above may be adapted for use with other photodissociation techniques that utilize radiation in other parts of the spectrum, e.g., infrared light. In such techniques, the UV source described above will be substituted with a source that emits a pulsed or continuous radiation beam of suitable wavelength(s) that is absorbed by the analyte (precursor) ions to cause their dissociation into product ions, and an excitation field is established, as described above, to cause the trajectories of the product ions, but not the precursor ions, to extend outside of the irradiated region in order to avoid subsequent nth-generation fragmentation of the product ions leading to overfragmentation and the loss of information in the product ion spectrum useful for structural elucidation or identification.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of dissociating precursor ions for analysis by mass spectrometry, comprising:
establishing a confinement field within an ion trap to cause the precursor ions to be substantially located within an ion cloud;
for an irradiation period, irradiating a region of the ion trap with ultraviolet radiation, the irradiated region overlapping with the ion cloud, such that some of the precursor ions undergo fragmentation into product ions; and
during at least part of the irradiation period, generating an excitation field within the ion trap to kinetically excite the product ions into trajectories that extend outside of the irradiated region.

2. The method of claim 1, wherein the ion trap is a two-dimensional quadrupole ion trap.

3. The method of claim 2, wherein the excitation field is a substantially dipolar excitation field.

4. The method of claim 2, wherein the excitation field is a quadrature excitation field.

5. The method of claim 1, wherein the irradiating step comprises irradiating the irradiated region in the ion trap with a sequential plurality of pulses of ultraviolet radiation.

6. The method of claim 5, wherein each of the plurality of pulses of ultraviolet radiation has an energy between 0.1 μJ and 8 mJ.

7. The method of claim 5, wherein the plurality of pulses number between 2 and 1000.

8. The method of claim 1, wherein the precursor ions comprise polypeptide ions.

9. The method of claim 1, wherein the irradiating step is performed using a solid state laser.

10. The method of claim 1, wherein the irradiating step is performed using an excimer laser.

11. The method of claim 2, wherein the step of generating an excitation field comprises applying a notched multifrequency waveform to at least one electrode of the ion trap, the waveform having a notch corresponding to the secular frequency of the precursor ions.

12. The method of claim 1, wherein the irradiating step comprises irradiating the irradiated region in the ion trap with a continuous beam of ultraviolet radiation.

13. The method of claim 1, wherein the excitation field is controlled to substantially avoid loss of product ions via ejection, collision with ion trap surfaces, or further fragmentation of product ions via collisional activation.

14. The method of claim 11, wherein the notched multifrequency waveform is adapted to substantially avoid further fragmentation of the product ions by collisionally activated dissociation.

15. Apparatus for dissociating precursor ions within a mass spectrometer, comprising:
an ion trap positioned to receive precursor ions, the ion trap having a plurality of electrodes;
at least one of a confinement voltage source and a magnet for establishing a confinement field within the ion trap to cause the precursor ions to be substantially located within an ion cloud;
a radiation source configured to irradiate an irradiated region of the ion trap with ultraviolet radiation during an irradiation period, the irradiated region overlapping with the ion cloud, such that some of the precursor ions undergo fragmentation into product ions; and
an excitation voltage source configured to generate an excitation field within the ion trap to kinetically excite the product ions into trajectories that extend outside of the irradiated region during at least part of the irradiation period.
